(19) United States
(12) Patent Application Publication
(10) Pub. No.: US 2007/0106506 A1
(43) Pub. Date: May 10, 2007

(54) Personal synergic filtering of multimodal inputs

(76) Inventors: Changxue C. Ma, Barrington, IL (US); Ted Mazurkiewicz, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/268,113

(22) Filed: Nov. 7, 2005

(51) Int. Cl. G10L 15/00

(52) U.S. Cl. 704/231

(57) ABSTRACT

A method and apparatus is provided for identifying an input sequence entered by a user of a communication unit. The method includes the steps of providing a database containing a plurality of partial sequences from the user of the communication unit, recognizing an identity of at least some information items of the input sequence entered by the user, comparing the recognized sequence of information items with the plurality of partial sequences within the database and selecting a partial sequence of the plurality of sequences within the database with a closest relative match to the recognized sequence as the input sequence intended by the user.

### FIELD OF THE INVENTION

The field of the invention relates to communication systems and more particularly to portable communication devices.

### BACKGROUND OF THE INVENTION

Portable communication devices, such as cellular telephones or personal digital assistants (PDAs), are generally known. Such devices may be used in any of a number of situations to establish voice calls or send text messages or communicate to other parties in virtually any place throughout the world.

Recent developments have simplified the control of the device such as the placement of voice calls by incorporating automatic speech recognition and hand-writing recognition into the functionality of portable communication devices. The use of such functionality has greatly reduced the tedious nature of entering numeric identifiers or text through a device interface.

Automatic speech recognition, or handwriting recognition, however, are not without shortcomings. Both systems use models trained on the collected data samples. There are often mismatches between the models and the users. The recognition of speech is based upon samples collected from many different users. Because recognition is based upon many different users, the recognition of any one user is often subject to significant errors. The errors are often systematic for the user.

In order to reduce the errors, the speech recognition unit and hand-writing recognition unit are often trained with input from a particular user. The requirement for training, however, involves significant processing effort and often still produces systematic errors. Accordingly, a need exists for a recognition method that is more adaptable to the individual user and makes corrections on the semantic level.

### DETAILED DESCRIPTION OF THE DRAWINGS

The present invention is illustrated by way of example, and not limitation in the accompanying figures, in which like references indicate similar elements, and in which:

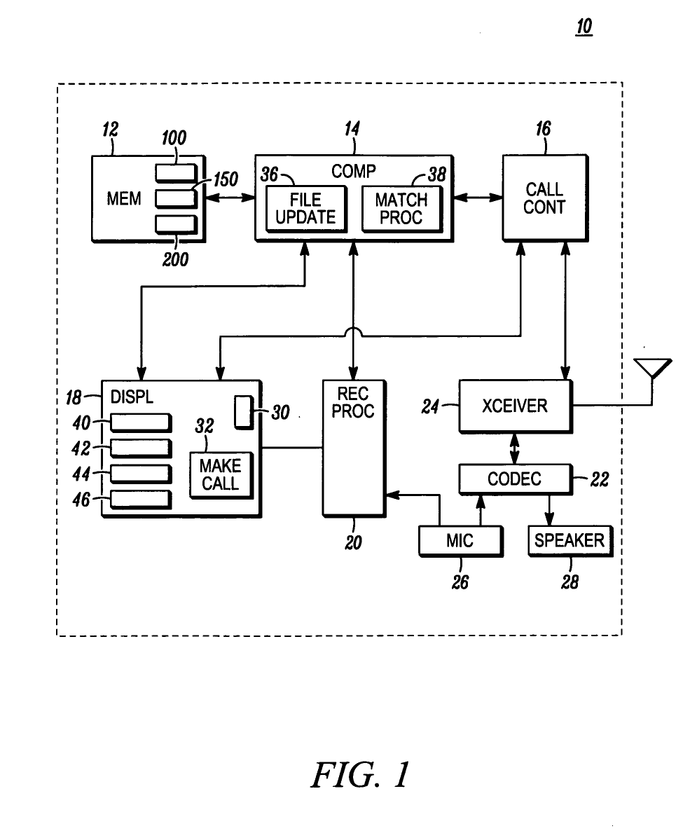

FIG. 1 is a block diagram of a communication unit that identifies a sequence entered by a user in accordance with an illustrated embodiment of the invention;

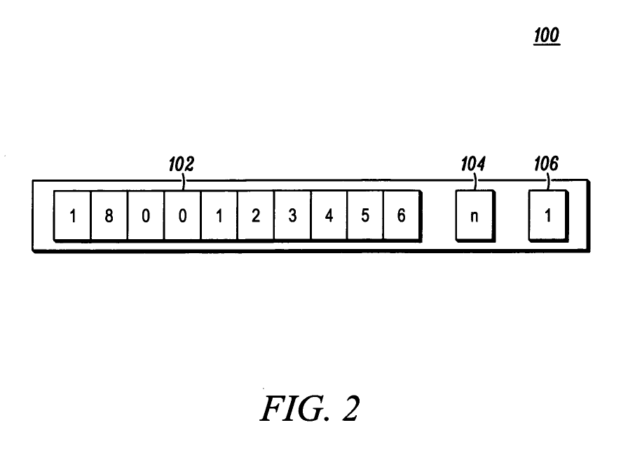

FIG. 2 is an example of a contact record that may be used by the communication unit of FIG. 1;

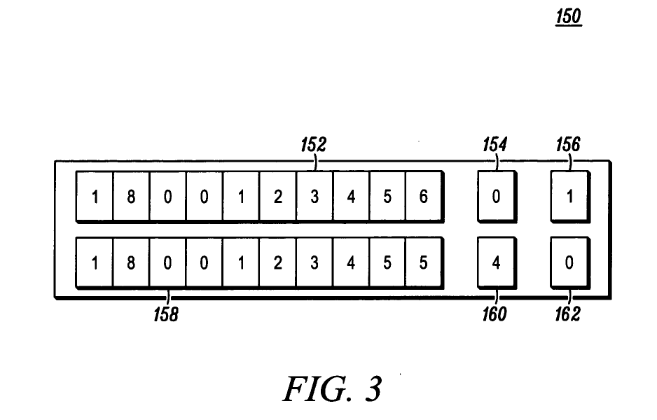

FIG. 3 is a second example of a contact record that may be used by the communication unit of FIG. 1

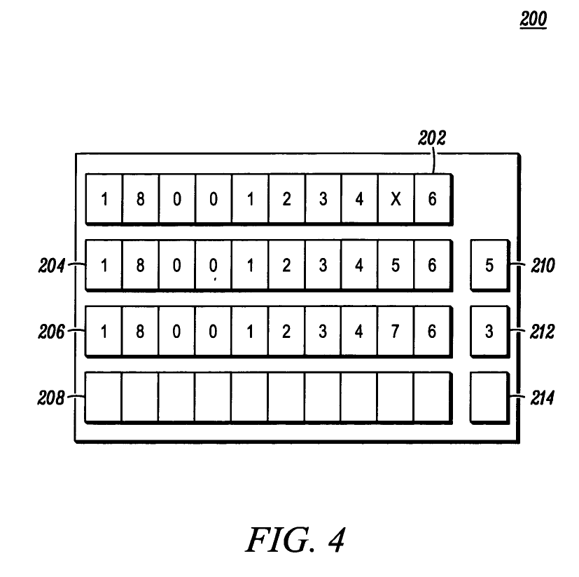

FIG. 4 is a third example of a contact record that may be used by the communication unit of FIG. 1;

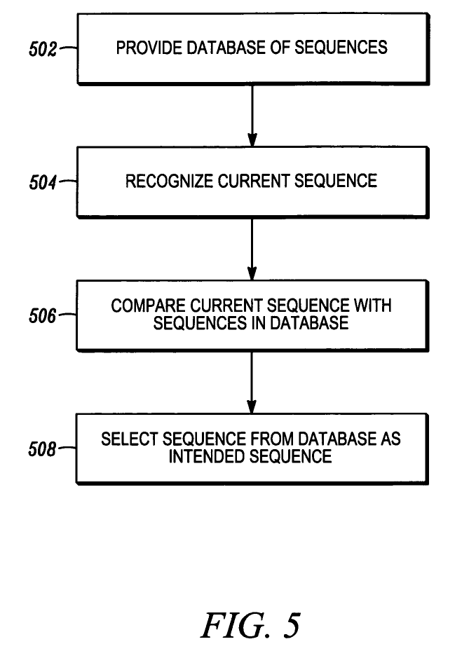

FIG. 5 is a flow chart of method steps that may be used by the communication unit of FIG. 1; and

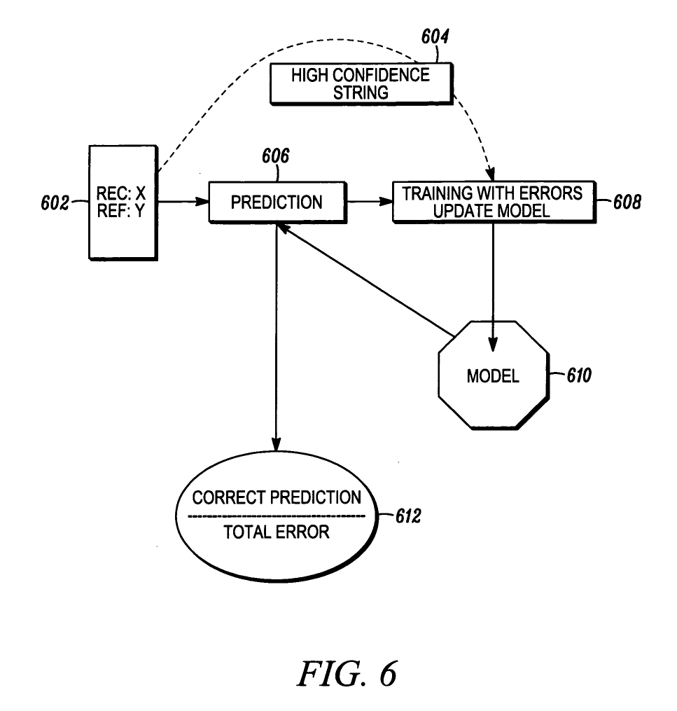

FIG. 6 is a flow diagram of process flow of the device of FIG. 1.

Skilled artisans will appreciate that elements in the figures are illustrated for simplicity and clarity and have not necessarily been drawn to scale. For example, the dimensions of some of the elements in the figures may be exaggerated relative to other elements, to help to improve understanding of embodiments of the present invention

### DETAILED DESCRIPTION OF THE INVENTION

A method and apparatus is provided for identifying an input sequence entered by a user of a communication unit. The method includes the steps of providing a database containing a plurality of partial sequences from the user of the communication unit, recognizing an identity of at least some information items of the input sequence entered by the user, comparing the recognized partial sequence of information items with the plurality of partial sequences within the database and selecting a sequence of the plurality of sequences within the database with a closest relative match to the recognized sequence as the input sequence intended by the user.

In general, the approach is-based on the text output from the speech recognition system or handwriting recognition. Errors may be directly detected based on the error patterns of a usage history of the individual user and may be used to predict the correct output. The method incrementally collects the user's error patterns based on daily use and the corrections made by the user. Since systematic word errors often appear within a certain context of words, any prediction about a word must take its context into consideration. Moreover, any error detection should be effective after one correction. For example, the user may recite the numbers “12456890”, where the corrected version is “12457890”. In this case, the user corrected the word (number) 6 to be a 7. After this correction, when the user recites the sequence “31456891”, the predicted output could be “31457891”, since the system detected the error pattern “45689” and corrected it to be “45789”.

Under one illustrated embodiment, each recognized word of a sequence is taken as a focused word and a prediction is made as to its correctness. A partial sequence of the focused word is formed by attaching its left and right context words. The partial sequence is matched with entries within an error-correction pattern database. If the match is found, then a prediction will be estimated based on the probability of an error-pattern. If no match is found, then the prediction module is bypassed.

In the example above, the partial sequences can have equal length. The focused words are attached with the left context words and right context words. The counts for the partial sequence are accumulated continuously and are used for estimating the prediction probability p(c|f ,l, r), where f maps to c, given a focused word f and its left context words l, right context words r.

For a long recognized sequence, a pointer moving from the beginning to the end may be used. The word identified by the pointer becomes the focused word. A partial sequence may be formed in conjunction with the context and the prediction probabilities for the focused word are calculated. The transformation of the focused word to the corrected word can be one to many. For the recognized sequence, a lattice of prediction probabilities is formed. The vertical axis is the prediction output sequence. The horizontal axis is the recognized word sequence.

The point corresponding to the cross point between horizontal axis and vertical axis is the prediction probability.

The partial sequence can also have varying length. In practice, there exist minimum and maximum lengths. The prediction probability is modulated by the length, where the longer partial sequences have higher weight and are more trust-worthy. The same length may be used for all partial sequences. In this case, every partial sequence may have the same weight for prediction.

Reference will now be made to the figures to describe the invention in greater detail. FIG. 1 is a simplified block diagram of a communication device 10 for recognizing input sequences from users in accordance with an illustrated embodiment of the invention. The device 10 may operate under any of a number of different formats (e.g., within a cellular telephone, personal digital assistant, etc.).

It should be understood that while the device 10 uses speech or character (script) recognition technology to provide an initial guess as to the user's intention, the device 10 does not rely upon speech or character recognition or upon training by the user to achieve a reliable result. Instead, the device 10 uses the past communication history of the user of the device to determine the intended target of the contact.

The past communication history may be received and processed by the device 10 under either of two different operating modes. For purposes of simplicity, it will be assumed that the recognition processor 20 is either an automatic speech recognition processor, a script recognition processor or both.

Accordingly, under a first mode, a verbal sequence may be received through a microphone 26 and recognized within the speech recognition processor 20. Under a second mode, a written sequence of characters may be entered through a display 18 using a light pen 30. In this case, the entered characters may be recognized by a script recognition processor 20.

Whether entered under the first or second mode, the recognized sequences 5 may be displayed on a display 18, corrected by the user and saved within a memory (database) 12. Once the database 12 has been created, new sequences may be compared with a content of the database 12 and corrected accordingly.

In general, contact records may be stored in the database 12 under an (r,c,n,1) format. In this case, “r” is the recognized sequence, “c” is the corrected l0 sequence, “n” is the number of occurrences and “1” is a record identifier, where the value “1” would indicate a recognized sequence.

For example, FIG. 2 shows a contact record 100 that may be stored within the memory 12. A first contact record element 102 may be a frequently repeated sequence of information elements (e.g., a 10 digit telephone number). In this 15 case, the record 100 has a recognized sequence “r” 102. If the recognized sequence 102 of the record 100 is correct, then the “c” field would be empty and the “n” field would contain the relative number of previous contacts using this record 100. The record identifier would have a “1” to indicate that this is a recognized sequence.

FIG. 3 shows another contact record 150 that may also be stored within memory 12. In FIG. 3, a first record element 152 may show a recognized sequence and a second record element 158 shows a corrected record element. An “n” value 154 of 0 indicates that the recognized sequence has not been previously used while the corrected sequence 158 shows an “n” value of 4 to indicate that the corrected sequence has been used 4 times.

FIG. 4 shows another, more complicated contact record 200 that may be stored within the memory 12. A first contact record element (field “r”) 202 may be a recognized sequence of information elements (e.g., a 10 digit telephone number). Included within the sequence 102 may be one or more “wild card” characters (shown in the form of an “X” in 202). Wild card characters are characters where the user has used different information elements in past contacts or the recognition processor 20 has (in past contacts) recognized the wrong information element.

Also included within the call record 200 may be one or more other corrected record elements 204, 206 that show a sequence of information elements that together form a communication system port identifier of past completed contacts. Associated with each record element 204, 206 may be a frequency record 210, 212 that shows how many times contacts have been completed to that destination.

As a further more detailed example (as illustrated in FIG. 5), the recognition processor 20 may be an automatic speech recognition processor and the device 10 may be a cellular telephone. A database 12 of sequences may be provided.

To make a call, the user may activate a MAKE CALL button 32 provided either as a soft key on the display 18 or as a discrete device disposed on outer surface of the device 10. In response, a call controller 16 may detect entry of the instruction and prepare the device 10 for receiving a set of information elements that identify a call destination. To receive the information elements, the call controller 16 may couple a speech recognition unit 20 to a microphone input 26 and to prepare the speech recognition unit 20 to receive and identify a telephone number.

As each spoken word is received by the recognition unit 20, the words (e.g., numbers) of a sequence may be recognized 504 and transferred to a matching processor 38 within a comparator processor 14 to form a string (search) segment. A search segment consists of a focused word and its left and right contexts. The search segment may have the form as follows:
L(2n+1): n left context words+focused word+n right context words,
or,
Lmn: m left context words+focused word+n right context word.
In this case, the search segment may include the same number n of context words on each side of the focused word or the number of words m on the left side of the focused word may be different than the number of words n on the right side.

Within the matching processor 38, the segment (sequence) is compared 506 with a content (sequences) within the records 100, 150, 200. A sliding window may be used to identify the focused word and context words. As a first step, the matching processor 38 may look for an exact match within the records 100. If an exact match is found (indicating a high level of confidence and there are no corrections associated with that record 100), then the matching processor 38 may select the sequence as the intended sequence 508, transfer the matched sequence to the call controller 16 and the call may be completed as recognized.

On the other hand, the matching processor 38 may match the recognized sequence with the sequence within the record element 152 where there has been a correction. In this case, the record element 152 has a corrected sequence 158 associated with the first record element 152. In order to determine which sequence to use, the matching processor 38 may compare a threshold value with the number of prior uses of the sequences. In the case of the record 150, the recognized sequence 152 has a number of prior uses 154 equal to 0 and the corrected sequence 158 has a number of prior uses 162 equal to 4. If the threshold value were set to some value above 2, then the corrected value 158 would be transferred to the call controller 16 and the call would be automatically placed.

In the case of the record 152, the substitution of the corrected sequence 158 is based upon prior uses. In this case, it may be that a speech recognition processor does not function properly for this user because the user mispronounces the number “6”, as shown in the call record 152. In this case, the system 10 provides a simple method of adapting speech recognition to the user without adaptation of the speech recognition algorithm.

Alternatively, if neither of the sequences 152, 158 exceeded the threshold, the sequences may each be displayed in a set of windows 40, 42. In the case of record 152 if the corrected sequence 158 were to have a larger number of prior uses, then the corrected sequence 158 may be displayed in the upper window 40 and the recognized sequence may be displayed in a second window 42. The user may place a cursor 30 and activate a switch on an associated mouse to select one of the sequences 152, 158. The user may then activate the MAKE CALL button 32 to complete the call.

In another more complex example, the recognition processor 20 may not always produce consistent results for numbers spoken by the user. In this case, the example of FIG. 4 applies where a recognized number is replaced by a “wild card”.

In this case, the matching processor may not find a close match in records 100, 150 and proceed to the additional records 200. If a match is found within the first record element 202 taking into account the wild cards, the corrected elements 204, 206 may be processed. Otherwise, the matching processor 38 may proceed to the next record 200.

If a match is found within the corrected elements 204, 206, then the number of prior uses may be compared with the threshold and the call may be automatically placed if the prior uses exceeded the threshold. Otherwise, the matching processor 38 may display an ordered set of sequences in windows 40, 42, 44. In this case, if one of the corrected elements 204, 206 is an exact match, then that sequence may be displayed in the uppermost window 40. Alternatively, if none of the corrected elements 204, 206 matches the recognized sequence, then the sequences of the corrected elements 204, 206 may be displayed in the order of prior use found in elements 210, 212, 214. As a further alternative, the recognized sequence may be displayed in the uppermost window 40 while the corrected sequences of that record 200 are displayed in order of use in the windows 42, 44 below the uppermost window 40.

The user may review the windows 40, 42, 44 and select one of the sequences by placing the cursor 30 over the window and activating a switch on a mouse associated with the cursor 30. The user may then activate the MAKE CALL soft key 32. Activating the MAKE CALL may cause the call processor 16 to place the call to the sequence associated with the selected window 40, 42, 44.

If the user should decide that the sequences in the windows 40, 42, 44 are all incorrect, then the user may place the cursor 30 over a digit in one of the sequences in the windows 40, 42, 44 and activate the switch on the mouse. Activating the switch on the mouse allows the user to enter or correct the information element. The user may then activate the MAKE CALL button to complete the call.

On the other hand, matching processor 38 may not find a match for the recognized number. If a match is not found within the records 200, then the matching processor 38 may assume that this is a first occurrence of this number and display the recognized number in a first window 40. If the user should decide that the displayed number is correct, the user may activate the MAKE CALL button 32. If the number is not correct, the user may edit the recognized number and then activate the MAKE CALL button 32.

Each time that the call controller 16 places the call, the call controller 16 may cause the selected sequence to be forwarded to an update processor 36. The update processor may update (FIG. 6) the call model (i.e., the call records 100, 200) based upon the sequence of the completed call.

As above, a sequence of words “x” may be recognized and matched with a reference sequence “y” 602. If the reference sequence is a high confidence string 603 (e.g., an exact match), then the match may be used to update the records of the model 608 (i.e., increment the frequency records 210, 212), with the results being added to the model 610 which is then made available to the prediction process 606.

If the recognized sequence is a new number and the user does not correct the recognized number of the prediction 606, then the update processor 36 may update the model 608 by creating a new record 100. The update processor 36 may also update fields 104, 106 of the record 100 as a correct prediction 612.

If the recognized sequence is a new number and the user corrects the prediction (i.e., the recognized number) 606, then the update processor 36 may create a new record 150. In this case, the correction of the prediction becomes a training sequence with errors 608. The training sequence with errors 608 is then used to correct the model 610 by adding the new record 150. The fields 154, 156, 160, 162 may be updated 612 with total errors.

If the new number is a correction of a previously used number 150, then the record 150 may be modified as shown in FIG. 4. If the selected number is related to another previously related sequence 202, then the update processor 36 may add a new element 208 and update a frequency element 214.

As briefly discussed above, the recognition processor 20 may also be a handwriting (script) recognition processor. In this case, the user may hand write a sequence of characters into a script input window 46. The (script) recognition processor 20 may recognize the script characters and form a search segment as discussed above. The results may be returned and displayed in the windows 40, 42, 44, as discussed above. The contact may be initiated automatically if the threshold level is exceeded or the user may correct the sequence as necessary.

In another embodiment, the word recognition (or script) processor 20 may use a spoken or written name used as a short hand reference to a communication system port identifier. In this case, the records may have the format 200 shown in FIG. 4.

In the case of a spoken name, the word recognition processor may (or may not) recognize the name “Bob”. Whether correctly recognized or not, the matching processor 38 would recognize that the sequence is not in the proper format (e.g., not a telephone number) and transfer the sequence to the matching processor 38. The matching processor 38 may search record elements 202 for the sequence Bob. If a match is not found, then the matching processor 38 may display the recognized sequence in the window 40. The user may edit the sequence and activate the MAKE CALL button 32. In this case, the call controller may recognize that the sequence is still not in a proper format and reject the call. In response, the matching processor 38 may display the corrected name “Bob” in the upper window 40 and request entry of a port identifier in a second window 42. If the port identifier entered into the second window 42 is in proper form, the contact is executed by the call controller 16.

In addition, a new record 200 is created. In this case, the recognized sequence is entered into the first element 202, the corrected sequence is entered into the second element 204 and the port identifier is entered into the third element 206. Subsequent entry of the name Bob will result in a contact being made to the identifier in the corrected element location 204.

In another embodiment, the port identifier within records 100, 150, 200 may be an e-mail or instant messaging address. In this case, once the user has identified the destination and activated the MAKE CALL button 32, the call (rather than placing a call) may simply open an instant messaging or e-mail message screen on the display 18.

In yet another embodiment, the port identifier may be an Internet address. In this case, the call controller 16 downloads a webpage associated with the address.

Specific embodiments of a method for identifying an input sequence have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of identifying an input sequence entered by a user of a communication unit, such method comprising:
providing a database containing a plurality of partial sequences from the user of the communication unit;
recognizing an identity of at least some information items of the input sequence entered by the user;
comparing the recognized partial sequence of information items with the plurality of partial sequences within the database; and
selecting a sequence of the plurality of sequences within the database with a closest relative match to the recognized sequence as the input sequence intended by the user.

2. The method of identifying the input sequence as in claim 1 further comprising defining the communication unit as a cellular telephone.

3. The method of identifying the input sequence as in claim 1 further comprising using an automatic speech recognition processor to recognize the identity of the at least some information items.

4. The method of identifying the input sequence as in claim 1 wherein the recognized sequence of information items further comprises a telephone number audibly provided by the user through a microphone input to the communication unit.

5. The method of identifying the input sequence as in claim 1 further comprising using a script character recognition processor to recognize the identity of the at least some information items entered through a script input window of the communication unit.

6. The method of identifying the input sequence as in claim 1 further comprising displaying the selected sequence of information items on a display of the communication unit.

7. The method of identifying the input sequence as in claim 6 further comprising displaying the recognized sequence of information items along with the recognized sequence.

8. The method of identifying the input sequence as in claim 7 further comprising the user placing a call by choosing one of the selected sequence and the recognized sequence.

9. The method of identifying the input sequence as in claim 8 further comprising the user correcting one of the selected sequence and the recognized sequence and initiating a call based upon the corrected sequence.

10. The method of identifying the input sequence as in claim 9 further comprising updating the plurality of sequences within the database based upon the corrected sequence.

11. An apparatus for identifying an input sequence entered by a user of a communication unit, such apparatus comprising:
a database containing a plurality of sequences from the user of the communication unit;
a recognition processor that recognizes an identity of at least some information items of the input sequence entered by the user;
a matching processor that compares the recognized sequence of information items with the plurality of sequences within the database; and
a selection device that selects a sequence of the plurality of sequences with a closest relative match to the recognized sequence as the input sequence intended by the user.

12. The apparatus for identifying the input sequence as in claim 11 wherein the communication unit further comprises a cellular telephone.

13. The apparatus for identifying the input sequence as in claim 11 wherein the recognition processor further comprises an automatic speech recognition processor.

14. The apparatus for identifying the input sequence as in claim 11 wherein the recognized sequence of information items further comprises a telephone number audibly provided by the user through a microphone input to the communication unit.

15. The apparatus for identifying the input sequence as in claim 11 wherein the recognition processor further comprising a script character recognition processor that recognizes script entered through a script input window of the communication unit.

16. The apparatus for identifying the input sequence as in claim 11 further comprising displaying the selected sequence of information items on a display of the communication unit.

17. The apparatus for identifying the input sequence as in claim 16 further comprising a display that displays the recognized sequence of information items along with the recognized sequence.

18. The apparatus for identifying the input sequence as in claim 17 further comprising a call controller that places a call when the user chooses one of the selected sequence and the recognized sequence.

19. The apparatus for identifying the input sequence as in claim 18 further comprising a cursor that allows the user to correct one of the selected sequence and the recognized sequence.

20. The apparatus for identifying the input sequence as in claim 19 further comprising an update processor that updates the plurality of sequences in the database.

21. An apparatus for identifying an input sequence entered by a user of a communication unit, such apparatus comprising:
a database containing a plurality of sequences from the user of the communication unit;
means for recognizing an identity of at least some information items in a sequence of information items of the input sequence entered by the user;
means for comparing the recognized sequence of information items with the plurality of sequences within the database; and
means for selecting a sequence of the plurality of sequences within the database with a closest relative match to the recognized sequence as the input sequence intended by the user.
